(19) United States
(12) Patent Application Publication
(10) Pub. No.: US 2026/0334508 A1
(43) Pub. Date: Oct. 29, 2026

(54) FIBER AGGREGATE AND MANUFACTURING METHOD FOR FIBER AGGREGATE

(71) Applicant: NITTO DENKO CORPORATION, Ibaraki-shi, Osaka (JP)

(72) Inventors: Yusuke KAMANO, Ibaraki-shi, Osaka (JP); Yosuke KONNO, Ibaraki-shi, Osaka (JP); Yasutaka KAWASAKI, Ibaraki-shi, Osaka (JP); Shinya HASHIGUCHI, Ibaraki-shi, Osaka (JP)

(21) Appl. No.: 19/486,101

(22) PCT Filed: Dec. 11, 2024
(86) PCT No.: PCT/JP2024/043909

§ 371 Date: Nov. 20, 2025

(30) Foreign Application Priority Data
Dec. 22, 2023 (JP) 2023-217255
Oct. 4, 2024 (WO) PCT/JP2024/035706

(51) Int. Cl. A23J 3/16; A23J 3/28; A23J 3/34

(52) U.S. Cl. CPC A23J 3/16; A23J 3/28; A23J 3/346

(57) ABSTRACT

The present invention provides a fiber aggregate having an improved texture. The fiber aggregate of the present invention includes a plurality of fibers. The fiber aggregate has a non-animal protein and an alginic acid compound including a divalent metal salt of alginic acid. In the fiber aggregate in a water-saturated state, a water content is 71 wt % or more, and a content of the alginic acid compound is 2.0 wt % or more in terms of sodium alginate. In the fiber aggregate, the water content is, for example, 88 wt % or less. The content of the alginic acid compound in terms of sodium alginate is, for example, 10 wt % or less.

### TECHNICAL FIELD

The present invention relates to a fiber aggregate and a manufacturing method for the fiber aggregate.

### BACKGROUND ART

Recently, demand for meat is expected to increase with an increasing world population. To meet the increasing demand for meat in the future, merely increasing production of conventional protein sources by enhancing production efficiency is insufficient, and new protein sources need to be developed. Examples of new protein sources include alternative foods such as plant-based meat produced from plants, meat produced from insects, and cultured meat produced by culturing microorganisms or cells themselves. These alternative foods are also attracting attention from an animal welfare perspective. Patent Literature 1 discloses a dried meat-like protein processed food as an example of an alternative food.

“Plant-based meat” is a processed food including a plant protein, such as soybean, as a raw material and produced by adding an additive to a plant protein and shaping the mixture. Plant-based meat is also called “fake meat”. “Cultured meat” means a meat produced by culturing muscle cells using regenerative medicine techniques, and it is also called “clean meat”.

### CITATION LIST

### Patent Literature

Patent Literature 1: JP 2022-118655A

### SUMMARY OF INVENTION

### Technical Problem

In recent years, aggregates of fibers including non-animal proteins (fiber aggregates) have been studied as alternative foods. Fiber aggregates have the advantage of easily mimicking a chunk of meat with a certain size, such as steak, sashimi, and a fillet. However, according to the study by the present inventors, fiber aggregates have room for improvement in terms of texture.

Therefore, the present invention aims to provide a fiber aggregate having an improved texture.

### Solution to Problem

Fiber aggregates as alternative foods are intended to be provided to eaters in a state of containing a certain amount or more of water (preferably in a water-saturated state). As a result of a detailed study, the present inventors have found that the water content and the content of an alginic acid compound in a fiber aggregate in a water-saturated state tend to correlate with the texture of the fiber aggregate. The present inventors have further conducted a study based on this finding and have completed the present invention.

The present invention provides a fiber aggregate including a plurality of fibers, wherein
the fiber aggregate has a non-animal protein and an alginic acid compound including a divalent metal salt of alginic acid, and
in the fiber aggregate in a water-saturated state,
a water content is 71 wt % or more, and
a content of the alginic acid compound is 2.0 wt % or more in terms of sodium alginate.

The present invention also provides a manufacturing method for a fiber aggregate including a plurality of fibers, wherein
the fiber aggregate has an alginic acid compound including a divalent metal salt of alginic acid,
the manufacturing method includes a spinning step of discharging a mixed solution containing a non-animal protein, a monovalent metal salt of alginic acid, and an alkaline compound, into a coagulation liquid to form the fibers,
the coagulation liquid has a metal salt including a divalent metal ion, and
a content of the monovalent metal salt of alginic acid in the mixed solution is greater than 0.5 wt %.

### Advantageous Effects of Invention

The present invention can provide a fiber aggregate having an improved texture.

### BRIEF DESCRIPTION OF THE DRAWINGS

FIG. 1 illustrates a manufacturing method for fibers included in a fiber aggregate.

FIG. 2 is an image showing a fiber aggregate of Example 1.

### DESCRIPTION OF EMBODIMENTS

A fiber aggregate according to a first aspect of the present invention is a fiber aggregate including a plurality of fibers, wherein
the fiber aggregate has a non-animal protein and an alginic acid compound including a divalent metal salt of alginic acid, and
in the fiber aggregate in a water-saturated state,
a water content is 71 wt % or more, and
a content of the alginic acid compound is 2.0 wt % or more in terms of sodium alginate.

In a second aspect of the present invention, for example, in the fiber aggregate according to the first aspect, the water content is 88 wt % or less, and the content of the alginic acid compound is 10 wt % or less in terms of sodium alginate.

In a third aspect of the present invention, for example, in the fiber aggregate according to the first or second aspect, a content of the non-animal protein in the fiber aggregate in the saturated state is 10 wt % to 27 wt %.

In a fourth aspect of the present invention, for example, in the fiber aggregate according to any one of the first to third aspects, the non-animal protein includes at least one selected from the group consisting of soybean protein, pea protein, lentil protein, potato protein, seitan protein, amaranth protein, and quinoa protein.

In a fifth aspect of the present invention, for example, in the fiber aggregate according to any one of the first to fourth aspects, the alginic acid compound further includes alginic acid.

In a sixth aspect of the present invention, for example, the fiber aggregate according to any one of the first to fifth aspects is edible.

In a seventh aspect of the present invention, for example, in the fiber aggregate according to any one of the first to sixth aspects, an average fiber diameter of the plurality of fibers is 1 cm or less.

In an eighth aspect of the present invention, for example, in the fiber aggregate according to any one of the first to seventh aspects, at least two fibers of the plurality of fibers are bound to each other.

A manufacturing method for a fiber aggregate according to a ninth aspect of the present invention is a manufacturing method for a fiber aggregate including a plurality of fibers, wherein
the fiber aggregate has an alginic acid compound including a divalent metal salt of alginic acid,
the manufacturing method includes a spinning step of discharging a mixed solution containing a non-animal protein, a monovalent metal salt of alginic acid, and an alkaline compound, into a coagulation liquid to form the fibers,
the coagulation liquid has a metal salt including a divalent metal ion, and
a content of the monovalent metal salt of alginic acid in the mixed solution is greater than 0.5 wt %.

In a tenth aspect of the present invention, for example, in the manufacturing method according to the ninth aspect, the coagulation liquid further contains an acid compound.

In an eleventh aspect of the present invention, for example, the manufacturing method according to the ninth or tenth aspect further includes a washing step of washing the fibers taken out from the coagulation liquid.

In a twelfth aspect of the present invention, for example, in the washing step of the manufacturing method according to the eleventh aspect, an alkaline aqueous solution or water is used as a washing liquid.

In a thirteenth aspect of the present invention, for example, the manufacturing method according to any one of the ninth to twelfth aspects further includes a binding step of binding at least two fibers of the plurality of fibers to each other.

In a fourteenth aspect of the present invention, for example, in the binding step of the manufacturing method according to the thirteenth aspect, the at least two fibers are bound to each other in a state where the plurality of fibers are housed in a molding die.

Hereinafter, the present invention will be described in detail. The following description is not intended to limit the present invention to specific embodiments.

### <Embodiment of Fiber Aggregate>

A fiber aggregate of the present embodiment includes a plurality of fibers. The fiber aggregate has a non-animal protein and an alginic acid compound including a divalent metal salt of alginic acid. In the fiber aggregate in a water-saturated state, a water content R1 is 71 wt % or more, and a content R2 of the alginic acid compound is 2.0 wt % or more in terms of sodium alginate. According to the study by the present inventors, the fiber aggregate in which the water content R1 and the content R2 of the alginic acid compound in a water-saturated state are adjusted to the above ranges tends to have an improved texture (particularly, hardness, juiciness, fiber texture, etc.).

In this description, the “water-saturated state” means that when the fiber aggregate is immersed in water at 25 °C for 1 minute, the weight change ratio of the fiber aggregate is 0.1% or less, preferably 0.05% or less, and more preferably 0.01% or less. The weight change ratio of the fiber aggregate means the ratio of the difference between a weight W1 (g) of the fiber aggregate before immersion in water and a weight W2 (g) of the fiber aggregate after immersion in water to the weight W1 (g) (100×|W2−W1|/W1).

### (Fibers)

As described above, the fiber aggregate includes a plurality of fibers. The fiber aggregate is preferably an aggregate obtained by aggregation of a plurality of fibers. In the fiber aggregate, it is preferable that the fibers themselves include a non-animal protein and an alginic acid compound. Specifically, in the fibers included in the fiber aggregate, it is preferable that in a water-saturated state, a water content r1 is 71 wt % or more and a content r2 of the alginic acid compound is 2.0 wt % or more in terms of sodium alginate. The fiber aggregate may include other fibers in addition to the fibers that satisfy the above composition but may not necessarily include other fibers. The fiber aggregate may include a plurality of types of fibers that satisfy the above composition.

According to another aspect, the present invention provides a fiber having a non-animal protein and an alginic acid compound including a divalent metal salt of alginic acid, wherein
in the fiber in a water-saturated state,
a water content r1 is 71 wt % or more, and
a content r2 of the alginic acid compound is 2.0 wt % or more in terms of sodium alginate.

Furthermore, in the fibers included in the fiber aggregate, it is preferable that in a water-saturated state, a content r3 of the non-animal protein is 10 wt % to 27 wt %. The description given later for the water content R1 and the contents R2 and R3 can be applied to the preferred numerical ranges and the measurement methods for the water content r1 and the contents r2 and r3.

The shapes of the fibers are not particularly limited. The fibers are preferably long fibers but may be short fibers. It is preferable that the fibers do not have a branched structure.

The fiber diameter of the fibers is, for example, 1 cm or less and may be 1 mm or less, 800 μm or less, 500 μm or less, 300 μm or less, 200 μm or less, or even 100 μm or less. With fibers having a smaller fiber diameter, it is easier to produce a fiber aggregate having a dense structure, so that there is a tendency that it is easier to reproduce the texture of a chunk of meat. The lower limit of the fiber diameter of the fibers is, for example, 1 μm or more and may be 5 μm or more, 10 μm or more, 30 μm or more, or even 50 μm or more. The fiber diameter of the fibers is preferably 50 μm to 200 μm. The fiber diameter can be determined by the following method. First, the fibers are observed using an optical microscope or a microscope. The diameters of the fibers are measured using a scale such as calipers in the obtained microscope image. The diameters of the fibers are measured at any number of measurement points (at least three points), and the average of the obtained measurement values is regarded as the fiber diameter.

The average fiber diameter of the plurality of fibers in the fiber aggregate is, for example, 1 cm or less and may be 1 mm or less, 800 μm or less, 500 μm or less, 300 μm or less, 200 μm or less, or even 100 μm or less. The lower limit of the average fiber diameter is, for example, 1 μm or more and may be 5 μm or more, 10 μm or more, 30 μm or more, or even 50 μm or more. The average fiber diameter is preferably 50 μm to 200 μm. The average fiber diameter means the average value of the diameters determined by the above-described method for any number of (at least five) fibers.

In the fiber aggregate, it is preferable that at least two fibers of the plurality of fibers are bound to each other. It is preferable that the fibers are directly bound to each other, and it is preferable that there is no binder described later, or the like, at the bound portion between the fibers. In the fiber aggregate, among the plurality of fibers, it is preferable that 10% or more of the fibers are bound to adjacent fibers, it is more preferable that 50% or more of the fibers are bound to adjacent fibers, and it is particularly preferable that substantially all of the fibers are bound to adjacent fibers. In the fiber aggregate, when the fibers are bound to each other, it is easier to maintain the shape of the fiber aggregate, and also the texture of the fiber aggregate tends to be improved. In the fiber aggregate, the fibers may not necessarily be bound to each other, and a binder may be packed between the fibers.

In the fiber aggregate, it is preferable that the plurality of fibers are oriented. The plurality of fibers may be oriented in a single direction or may be oriented in two or more directions. The full width at half maximum (FWHM) of the orientation distribution of the plurality of fibers is, for example, 10° or more and may be 20° or more, 30° or more, 40° or more, 50° or more, 60° or more, 70° or more, or even 80° or more. In particular, it is preferable that the plurality of fibers are oriented in the same direction as the muscle fibers included in the meat to be mimicked.

The fiber aggregate preferably includes the fibers (fibers including a non-animal protein and an alginic acid compound) as a main component. In this description, the “main component” means a component included in the largest amount by weight ratio in the fiber aggregate. The content of the fibers in the fiber aggregate is, for example, 60 wt % or more and may be 80 wt % or more, 90 wt % or more, 95 wt % or more, or even 98 wt % or more. The fiber aggregate may be composed substantially of the fibers alone.

### (Non-Animal Protein)

As described above, the fiber aggregate includes a non-animal protein. The non-animal protein refers to a protein other than animal proteins derived from animals. The non-animal protein is a component suitable for adjusting the nutritional value of the fiber aggregate.

The non-animal protein preferably includes a plant protein. Examples of the plant protein include: bean proteins such as soybean protein, pea protein, and lentil protein; potato protein; seitan protein; amaranth protein; and quinoa protein. The non-animal protein preferably includes at least one selected from the group consisting of soybean protein, pea protein, lentil protein, potato protein, seitan protein, amaranth protein, and quinoa protein as a plant protein, and particularly preferably includes soybean protein. The non-animal protein is not limited to a plant protein. The non-animal protein may include a protein derived from fungus.

In the fiber aggregate in a water-saturated state, the content R3 of the non-animal protein is, for example, 5.0 wt % or more and may be 8.0 wt % or more, 10 wt % or more, 13 wt % or more, 15 wt % or more, 18 wt % or more, or even 20 wt % or more. The content R3 of the non-animal protein is preferably higher than the content R2 of the alginic acid compound. The content R3 of the non-animal protein is, for example, 27 wt % or less and may be 25 wt % or less or even 24 wt % or less. The content R3 of the non-animal protein is preferably 10 wt % to 27 wt %. The weight ratio of the non-animal protein to the solid component of the fiber aggregate is, for example, 40 wt % to 95 wt %.

As described later, the fibers included in the fiber aggregate of the present embodiment can be produced by a method in which a mixed solution containing a non-animal protein, a monovalent metal salt of alginic acid, and an alkaline compound is discharged into a coagulation liquid. In this case, it is difficult for the solid component of the mixed solution (particularly the non-animal protein and the monovalent metal salt of alginic acid) to dissolve into the coagulation liquid, so that the formed fibers tend to include the solid component of the mixed solution as it is. Therefore, in a fiber aggregate composed substantially of these fibers alone, the content R3 of the non-animal protein can be calculated as the product of a weight ratio C1 of the solid component in the fiber aggregate in a water-saturated state and a weight ratio C2 of the non-animal protein to the solid component in the mixed solution. According to the study by the present inventors, the content R3 calculated by this method tends to agree well with actual measurement values.

### (Alginic Acid Compound)

As described above, the fiber aggregate includes an alginic acid compound. The alginic acid compound is a component suitable for adjusting the elasticity of the fiber aggregate.

As described above, the alginic acid compound includes a divalent metal salt of alginic acid. The divalent metal salt of alginic acid is typically a salt of alginic acid and a divalent metal ion. In this description, the “divalent metal salt of alginic acid” is sometimes referred to simply as “alginate”. The alginic acid compound preferably further includes alginic acid in addition to the alginate. In this case, the texture of the fiber aggregate tends to be further improved.

Alginic acid is a polysaccharide included, for example, in seaweeds, etc., and has a structural unit (M-block) derived from β-D-mannuronic acid and a structural unit (G-block) derived from α-L-guluronic acid. In alginic acid, the structural units are bonded via a 1,4-glycosidic bond. The G-block content of alginic acid is not particularly limited and is, for example, 30 mol % or more, preferably 40 mol % or more, and more preferably 50 mol % or more. The upper limit of the G-block content may be 90 mol % or 80 mol %. The G-block content may be 31 mol % to 63 mol %.

As an example, in the alginate, at least one G-block included in the alginic acid forms an ionic bond with the divalent metal ion. In other words, in the alginate, the alginic acid at least partially forms a salt with the divalent metal ion. The alginate typically has a crosslinked structure mediated by the divalent metal ion. Examples of the divalent metal ion include a calcium ion, a magnesium ion, a barium ion, an iron ion, a zinc ion, a copper ion, and an aluminum ion, and a calcium ion is preferred.

In the fiber aggregate in a water-saturated state, the content R2 of the alginic acid compound is 2.0 wt % or more and may be 2.3 wt % or more, 2.5 wt % or more, 2.8 wt % or more, 3.0 wt % or more, 3.3 wt % or more, 3.5 wt % or more, or even 3.8 wt % or more in terms of sodium alginate. There is a tendency that the higher the content R2 of the alginic acid compound is, the better the elasticity of the fiber aggregate is, and accordingly, the better the texture of the fiber aggregate is made. If the content R2 of the alginic acid compound in terms of sodium alginate is significantly below 2.0 wt %, the fiber aggregate tends to have a brittle texture. The upper limit of the content R2 of the alginic acid compound in terms of sodium alginate is, for example, 10 wt % or less and may be 8.0 wt % or less, 5.0 wt % or less, or even 4.0 wt % or less. The content R2 of the alginic acid compound is preferably 2.0 wt % to 10 wt % in terms of sodium alginate. The weight ratio of the alginic acid compound in terms of sodium alginate to the solid component of the fiber aggregate is, for example, 5 wt % to 40 wt %.

The content R2 of the alginic acid compound can be determined by the colorimetric method described in “Analytical Methods for Food Additives in Food” of the Food Chemistry Division, Environmental Health Bureau, Ministry of Health, Labor and Welfare, 2000, 2nd edition, pages 90 to 92. In the colorimetric method, when preparing a measurement sample, the alginic acid compound is converted to a sodium alginate, so that the content R2 of the alginic acid compound is determined as a value converted in terms of sodium alginate.

As described above for the content R3 of the non-animal protein, the fibers included in the fiber aggregate of the present embodiment can be produced by a method in which a mixed solution containing a non-animal protein, a monovalent metal salt of alginic acid, and an alkaline compound is discharged into a coagulation liquid. In this case, it is difficult for the solid component of the mixed solution (particularly, the non-animal protein and the monovalent metal salt of alginic acid) to dissolve into the coagulation liquid, so that the formed fibers tend to include the solid component of the mixed solution as it is. When fibers are produced using sodium alginate as the monovalent metal salt of alginic acid, the content R2 of the alginic acid compound in terms of sodium alginate in a fiber aggregate composed substantially of these fibers alone can be calculated as the product of the weight ratio C1 of the solid component in the fiber aggregate in a water-saturated state and a weight ratio C3 of the sodium alginate to the solid component in the mixed solution. According to the study by the present inventors, the content R2 calculated by this method tends to agree well with actual measurement values.

### (Water)

In the fiber aggregate in a water-saturated state, the water content R1 is 71 wt % or more as described above and may be 72 wt % or more or even 73 wt % or more. There is a tendency that the higher the water content R1 is, the better the juiciness and moistness of the fiber aggregate is, and accordingly, the better the texture of the fiber aggregate is made. The upper limit of the water content R1 is, for example, 88 wt % or less and may be 85 wt % or less, 83 wt % or less, or even 80 wt % or less. The water content R1 is preferably 71 wt % to 88 wt % and more preferably 71 wt % to 80 wt %. The weight ratio of the solid component in the fiber aggregate in a water-saturated state is, for example, 12 wt % to 29 wt % and preferably 20 wt % to 29 wt %.

The water content R1 can be determined by the following method. First, the fiber aggregate in a water-saturated state is prepared, and a weight W3 (g) thereof is measured. The weight W3 is preferably 1 g. Next, this fiber aggregate is set in a heating-type moisture meter, and heating treatment is performed at 105 °C. This heating treatment causes the water included in the fiber aggregate to evaporate. The heating treatment is performed until the rate of water loss in the fiber aggregate falls below 0.10 wt %/min. The water content R1 can be calculated using the following formula based on the weight W3 and a weight W4 (g) of the fiber aggregate after the heating treatment.

Water content R1(wt %)=100×(weight W3−weight W4)/weight W3

In the fiber aggregate of the present embodiment, the water content R1 in a water-saturated state may be 71 wt % or more, and if the fiber aggregate is not saturated with water, the water content may be less than 71 wt %. In particular, during storage, transportation, etc., it is preferable that the water content of the fiber aggregate is lower, and this water content is, for example, 50 wt % or less and may be 30 wt % or less, 10 wt % or less, 5 wt % or less, 1 wt % or less, or even 0.1 wt % or less. The fiber aggregate having a low water content is also suitable for use as a scaffold for producing cultured meat. Meanwhile, a fiber aggregate to be provided to an eater preferably has a water content of 60 wt % or more (particularly, 65 wt % or more or 71 wt % or more).

### (Other Components)

The fiber aggregate of the present embodiment may further include or may not necessarily include other components in addition to the non-animal protein, the alginic acid compound, and water. Examples of the other components include an animal protein, a lipid, an alkaline compound, a coagulating agent, an acid compound, a softener, a lubricant, a compound C that promotes binding of fibers, a binder, a spice, and a seasoning. In the fiber aggregate, the fibers themselves may include the above other components.

Examples of the lipid include beeswax, phospholipids, and fatty acids. The alkaline compound, the coagulating agent, and the acid compound are derived from the materials used to produce the fibers and will be described in detail later. Examples of the lubricant include glycerin. The lubricant is suitable for inhibiting the fibers from being abraded due to contact with a free roller, a guide, etc., during winding of the fibers, etc.

Examples of the compound C include enzymes that crosslink proteins such as transglutaminase (protein crosslinking enzymes). In some cases, a protease such as papain can also be used as the compound C. However, the fiber aggregate may not necessarily include a protease.

The binder is a component that fixes the fibers by being packed between the fibers. With the binder, it tends to be easier to maintain the shape of the fiber aggregate. Examples of the binder include methylcellulose and alginic acid compounds. However, the fiber aggregate may not necessarily include a binder.

In the fiber aggregate in a water-saturated state, the content of the other components is, for example, 25 wt % or less and may be 20 wt % or less, 15 wt % or less, 10 wt % or less, 5 wt % or less, 1 wt % or less, or even 0.1 wt % or less.

The fiber aggregate of the present embodiment is typically edible. In this description, the “fiber aggregate is edible” means that the fiber aggregate is composed of only substances recognized as food or food additives under applicable laws and regulations of each country, etc. It is preferable that the fiber aggregate does not substantially include components other than food or food additives, such as a plasticizer (softener) and a surfactant.

### (Shape of Fiber Aggregate)

The shape of the fiber aggregate is not particularly limited, and examples thereof include a sheet shape, a cube shape, and a disk shape. The fiber aggregate preferably has a shape similar to that of the meat to be mimicked. Examples of the meat to be mimicked include meats such as crustaceans, shellfish, fish, beef, pork, and poultry (especially chicken). The fiber aggregate preferably has a shape that is the shape of chicken (especially chicken breast meat).

### (Manufacturing Method for Fiber Aggregate)

A manufacturing method for the fiber aggregate of the present embodiment includes a spinning step of discharging a mixed solution containing a non-animal protein, a monovalent metal salt of alginic acid, and an alkaline compound, into a coagulation liquid to form fibers. The fiber aggregate can be produced by aggregating the plurality of fibers obtained by the spinning step. The coagulation liquid has a metal salt including a divalent metal ion. The content of the monovalent metal salt of alginic acid in the mixed solution is greater than 0.5 wt %. The monovalent metal salt of alginic acid is typically a salt of alginic acid and a monovalent metal ion. In this description, the “monovalent metal salt of alginic acid” is sometimes referred to simply as “alginate”.

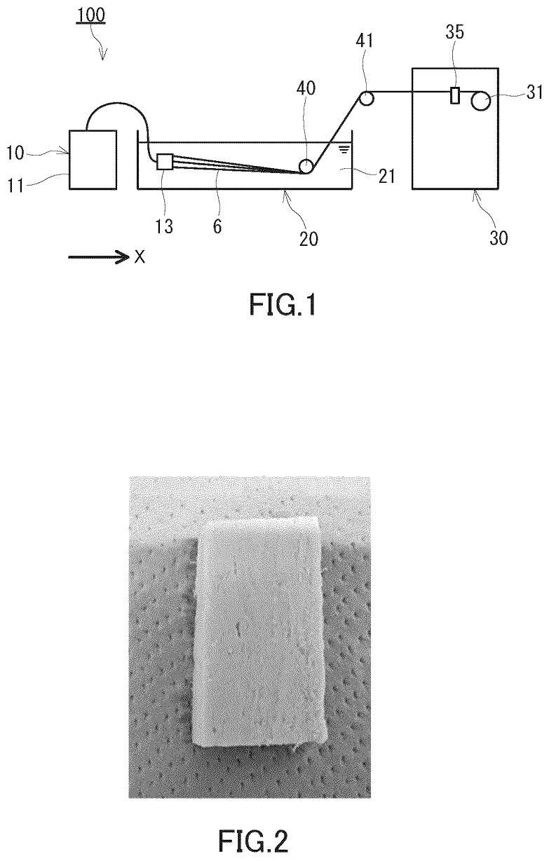

The spinning step can be performed, for example, using a spinning apparatus 100 shown in FIG. 1. The spinning apparatus 100 includes a discharge unit 10 that discharges the above mixed solution, a coagulation unit 20 that houses therein a coagulation liquid 21 for coagulating a discharge material from the discharge unit 10, and a winding unit 30 that winds a fiber 6 formed in the coagulation unit 20. The discharge unit 10, the coagulation unit 20, and the winding unit 30 are arranged, for example, in this order along a direction in which the fiber 6 is wound by the winding unit 30 (direction X).

The discharge unit 10 has a housing portion 11 that houses therein a mixed solution, and a nozzle 13 that discharges the mixed solution. As the discharge unit 10, a discharge device including a commercially available gear pump or syringe pump, or the like can be used. The mixed solution housed in the housing portion 11 contains a non-animal protein, an alginate, and an alkaline compound as described above.

Examples of the non-animal protein contained in the above mixed solution include those described above for the fibers. The non-animal protein normally has a unique three-dimensional structure based on an amino acid sequence. However, in the above mixed solution, due to the presence of the alkaline compound, the three-dimensional structure of the non-animal protein tends to be destroyed, making the non-animal protein have a string-like structure. In this description, the destruction of the three-dimensional structure of the non-animal protein by the alkaline compound is sometimes referred to as “unfolding”.

According to the study by the present inventors, by mixing the non-animal protein and the alkaline compound and performing a spinning step in a state where the non-animal protein is unfolded, it is easier to adjust the water content R1 to 71 wt % or more while adjusting the content R2 of the alginic acid compound (in terms of sodium alginate) in the fiber aggregate in a water-saturated state (particularly, the fibers included in the fiber aggregate) to 2.0 wt % or more.

In addition, by unfolding the non-animal protein, the solubility of the non-animal protein in the mixed solution tends to be improved, making it easier to form fibers. In other words, the spinnability of the mixed solution tends to be improved. When the unfolded non-animal protein is used, the obtained fibers tend to have improved strength.

The content of the non-animal protein in the mixed solution is not particularly limited and is, for example, 1.0 wt % to 30 wt %.

Examples of the monovalent metal ion in the alginate (monovalent metal salt of alginic acid) contained in the mixed solution include alkali metal ions such as a sodium ion and a potassium ion, and a sodium ion is preferred. In the mixed solution, typically, the alginate substantially includes no divalent metal ion.

As described above, the content of the alginate in the mixed solution is preferably greater than 0.5 wt % and may be 0.8 wt % or more, 0.9 wt % or more, 1.0 wt % or more, or even 1.1 wt % or more. The upper limit of the content of the alginate is not particularly limited and is, for example, 5.0 wt % or less. If the content of the alginate is significantly below 0.5 wt %, it tends to be difficult to spin the fiber 6.

As described above, the alkaline compound is a component for unfolding the non-animal protein in the mixed solution. The alkaline compound is preferably edible.

Examples of the alkaline compound include sodium hydroxide and sodium bicarbonate (baking soda), and the alkaline compound is preferably sodium hydroxide. The content of the alkaline compound in the mixed solution is, for example, 10 wt ppm to 5000 wt ppm.

The pH of the mixed solution is preferably adjusted to 8 or higher by the alkaline compound. When the pH of the mixed solution is 8 or higher, the non-animal protein tends to be unfolded in the mixed solution. The pH of the mixed solution is preferably 8 to 13 and more preferably 9 to 11.

The mixed solution preferably further contains water. The content of the water in the mixed solution is not particularly limited and is, for example, 50 wt % to 98.5 wt %.

The mixed solution may further contain the components described above (a softener, a lubricant, etc.) as other components to be included in the fiber aggregate.

In the discharge unit 10, the mixed solution is sent from the housing portion 11 to the nozzle 13 and discharged from a discharge port of the nozzle 13 to the outside of the discharge unit 10. The discharge rate of the mixed solution from the nozzle 13 is not particularly limited and is, for example, 0.1 to 10000 mL/min. The size of the discharge port of the nozzle 13 can be adjusted as appropriate according to the fiber diameter of the desired fiber 6. The nozzle 13 may have a plurality of discharge ports. In this case, a plurality of fibers 6 can be produced at a time by coagulating the discharge material discharged from the nozzle 13. The number of discharge ports in the nozzle 13 is not particularly limited and is, for example, 1 to 20000. If a nozzle 13 having a large number of discharge ports is used and the discharge rate of the mixed solution is set to a high value, the fibers 6 can be efficiently produced, thereby improving productivity. The nozzle 13 is, for example, immersed in the coagulation liquid 21 housed in the coagulation unit 20.

The coagulation liquid 21 housed in the coagulation unit 20 can coagulate the discharge material (mixed solution) discharged from the nozzle 13, by coming into contact with the discharge material. As the discharge material from the nozzle 13 is coagulated, the fiber 6 is formed. The coagulation liquid 21 is typically an aqueous solution containing a coagulating agent.

The coagulation liquid 21 contains a metal salt including a divalent metal ion, as a coagulating agent. Examples of the metal salt include chlorides such as calcium chloride and carbonates such as calcium carbonate. The metal salt including a divalent metal ion generates a divalent metal ion, for example, when being dissolved in the coagulation liquid 21. The divalent metal ion can form an ionic bond with the G-block of the alginate. Specifically, the metal ion (monovalent metal ion) included in the alginate is exchanged with the divalent metal ion in the mixed solution, thereby causing a plurality of alginic acid molecules to crosslink via the divalent metal ion. This crosslinking reaction promotes the gelation of the discharge material discharged from the nozzle 13, to obtain the fiber 6. The content of the coagulating agent in the coagulation liquid 21 is not particularly limited and is, for example, 0.1 wt % to 10 wt %.

The coagulation liquid 21 preferably further contains an acid compound in addition to the coagulating agent (metal salt). If the coagulation liquid 21 contains an acid compound, the three-dimensional structure of the unfolded non-animal protein can be returned to the original structure when the discharge material discharged from the nozzle 13 comes into contact with the coagulation liquid 21. In this description, the return of the three-dimensional structure of the unfolded non-animal protein to the original structure is sometimes referred to as “refolding”.

The acid compound is preferably edible. The acid compound is not particularly limited, examples of the acid compound include citric acid and acetic acid, and the acid compound is preferably citric acid. The content of the acid compound in the coagulation liquid 21 is not particularly limited and is, for example, 0.1 wt % to 10 wt %.

The coagulation liquid 21 may contain a mixture of an acid compound and an alkaline compound. The alkaline compound contained in the coagulation liquid 21 is not particularly limited and examples of the alkaline compound include sodium hydroxide and sodium bicarbonate.

The pH of the coagulation liquid 21 is preferably adjusted to 6 or lower by the acid compound or the mixture of the acid compound and the alkaline compound. The pH of the coagulation liquid 21 is particularly preferably 1 to 6. Within the above pH range, the non-animal protein can be refolded.

The fiber 6 formed in the coagulation unit 20 is sent to the winding unit 30. The spinning apparatus 100 may further include free rollers 40 and 41 for sending the fiber 6 to the winding unit 30. The free roller 40 is, for example, placed in the coagulation liquid 21 and is located approximately 10 cm to 10 m away from the nozzle 13. The fiber 6 passes through the free roller 40 and is then sent to the outside of the coagulation unit 20. The fiber 6 sent to the outside of the coagulation unit 20 passes through the free roller 41 and is then sent to the winding unit 30. The spinning apparatus 100 may not necessarily include the free rollers 40 and 41.

The winding unit 30 has a bobbin 31 that winds the fiber 6 formed in the coagulation unit 20, and a guide 35 for traversing the fiber 6 when winding the fiber 6. The rotation speed of the bobbin 31 is not particularly limited and is, for example, 0.1 to 500 rps. The winding speed of the fiber 6 by the bobbin 31 is not particularly limited and is, for example, 0.1 to 500 m/min. The number of traverses per second is not particularly limited and is, for example, 0.1 to 10. The traverse speed is not particularly limited and is, for example, 10 to 500 mm/sec. The traverse speed means the average speed of the reciprocating motion of the guide 35 in a direction orthogonal to the direction X. The winding unit 30 may not necessarily have the guide 35.

The manufacturing method of the present embodiment preferably further includes a washing step of washing the fiber 6 taken out from the coagulation liquid 21. With the washing step, the excess coagulating agent, acid compound, etc., adhering to the surface of the fiber 6 can be removed. The temperature of a washing liquid used in the washing step is, for example, room temperature (25 °C). The time for which the fiber 6 is brought into contact with the washing liquid is not particularly limited and is, for example, 1 second to 1 hour.

In the washing step, an alkaline aqueous solution or water is preferably used as the washing liquid. The alkaline aqueous solution is, for example, an aqueous solution containing an alkaline compound, and as the alkaline compound, one of those described above can be used. The content of the alkaline compound in the alkaline aqueous solution is not particularly limited and is, for example, 0.05 wt % to 10 wt %. The pH of the alkaline aqueous solution is preferably adjusted to 8 or higher and is particularly preferably 8 to 11.

The washing step may be performed before the fiber 6 is wound onto the bobbin 31 or after the fiber 6 is wound onto the bobbin 31. As an example, the washing step may be performed using a washing tank (not shown) that is placed between the coagulation unit 20 and the winding unit 30 and contains the washing liquid. With the washing tank, the fiber 6 sent from the coagulation unit 20 can be washed by bringing the fiber 6 into contact with the washing liquid. The washed fiber 6 is sent from the washing tank to the winding unit 30 and wound onto the bobbin 31. As another example, the washing step may be performed by pouring the washing liquid onto a wound body formed by winding the fiber 6 onto the bobbin 31 or immersing the wound body together with the bobbin 31 in the washing liquid. Furthermore, the washing step may be performed by bringing the fiber 6 removed from the bobbin 31 into contact with the washing liquid.

The manufacturing method of the present embodiment may further include a drying step of drying the fiber 6. With the drying step, the water content of the fiber 6 can be adjusted to a desired value. The conditions of the drying step are not particularly limited, and for example, the fiber 6 may be dried by leaving the fiber 6 at room temperature (25 °C). In the drying step, freeze drying or heating drying may be performed. When performing heating drying, the heating temperature of the fiber 6 is, for example, 50 °C to 120 °C. Before performing heating drying, the fiber 6 may be immersed in an alcohol such as ethanol to replace the water included in the fiber 6 with the alcohol.

The manufacturing method of the present embodiment preferably further includes a binding step of binding at least two fibers 6 of the plurality of fibers 6 to each other. The binding of the fibers 6 can be performed, for example, by the following method. First, the plurality of fibers 6 are housed in a molding die. The molding die has, for example, a housing portion having a shape similar to the meat to be mimicked. Next, the compound C that promotes the binding of the fibers 6 is added to the molding die and brought into contact with the plurality of fibers 6. A dispersion liquid obtained by dispersing the compound C in water may be added to the molding die. The binding of the fibers 6 proceeds due to the contact with the compound C. As an example, when the compound C is a protein crosslinking enzyme, the non-animal protein present near the surface of a fiber 6 and the non-animal protein present near the surface of another fiber 6 crosslink with each other. When an enzyme is used as the compound C, it is preferable to adjust the temperature inside the molding die to around the optimal temperature for the enzyme (e.g., 50 °C).

In the binding step, the interior of the molding die may be pressurized. In the binding step, the interior of the molding die may be pressurized, for example, from the atmospheric pressure of the ambient environment to 0.01 kPa to 100 kPa. The pressurization time is, for example, 1 second to 10 hours. Under pressurization, it is easier for the fibers 6 to come into contact with each other, so that the binding of the fibers 6 tends to be promoted. Furthermore, by performing the binding step under pressurization, the pores in the fiber aggregate also tend to be reduced.

The binding of the fibers 6 may be performed without using a molding die. For example, the fibers 6 may be bound by kneading the plurality of fibers 6 and the compound C (or a dispersion liquid containing the compound C).

The manufacturing method of the present embodiment may not necessarily include the above binding step. As an example, the manufacturing method of the present embodiment may include a mixing step of mixing the plurality of fibers 6 and a binder, instead of the above binding step. In the mixing step, one of those described above can be used as the binder.

The manufacturing method of the present embodiment may further include a heating step of heating the fiber aggregate obtained by the binding step (or mixing step). With the heating step, non-animal proteins included in the fibers 6 may aggregate, thereby further improving the texture of the fiber aggregate. The heating step may also serve as a sterilization treatment for the fiber aggregate. The conditions of the heating step are not particularly limited, and for example, the temperature is 50 °C to 120 °C and the time is 1 minute to 1 hour.

### (Applications of Fiber Aggregate)

The fiber aggregate of the present embodiment tends to have an improved texture. The fiber aggregate is particularly suitable for use as an alternative food for meat such as crustaceans, shellfish, fish, beef, pork, and poultry (especially chicken). In some cases, the fiber aggregate can also be used as a scaffold for cultured meat. That is, cultured meat can be produced by attaching cells from crustaceans, shellfish, fish, cattle, pigs, birds (especially chickens), or the like to the fiber aggregate and culturing these cells. When the fiber aggregate is used as a scaffold for cultured meat, the fiber aggregate may be provided with an adhesion enhancer that improves the adhesion to cells. The fiber aggregate can also be used in applications other than a scaffold for cultured meat, for example, in chemical products, chemicals, and the like.

### EXAMPLES

Hereinafter, the present invention will be described in more detail using Examples and Comparative Examples. The present invention is not limited to these examples.

### Example 1

First, distilled water was added to a disposable cup and stirred with a homogenizer (T 18, manufactured by IKA). The amount of distilled water added was adjusted such that the total weight of the materials added to the cup was 100 parts by weight. Next, 7.5 parts by weight of soybean protein (FUJIPRO 748, manufactured by FUJI OIL CO., LTD.) and 1.1 parts by weight of sodium alginate powder (KIMICA ALGIN I-1G, manufactured by KIMICA Corporation) were added to the cup in this order, little by little, and dissolved in water such that lumps were not formed. Furthermore, 3 parts by weight of a sodium hydroxide aqueous solution having a concentration of 5 wt % was added per 100 parts by weight of the total weight of the materials added to the cup. This mixed solution was stirred and defoamed using Awatori-Rentaro (ARV-310, manufactured by THINKY CORPORATION) at a rotation speed of 2000 rpm and a pressure of 0.6 kPa for an operating time of 5 minutes. Accordingly, a mixed solution containing a non-animal protein, an alginate (monovalent metal salt of alginic acid), and an alkaline compound was prepared. The content of sodium hydroxide in the mixed solution was 1500 wt ppm, and the pH of the mixed solution was 10.3. In the mixed solution, the soybean protein was unfolded by sodium hydroxide.

Next, fibers were produced by the following method using the above-described spinning apparatus 100. First, a discharge device including a gear pump was prepared as the discharge unit of the spinning apparatus. A multi-hole nozzle was used as the nozzle of the discharge unit. The multi-hole nozzle had 50 discharge ports with a diameter of 0.2 mm. Next, the above mixed solution was injected into the housing portion of the discharge unit and discharged from the nozzle. The discharge rate of the mixed solution from the nozzle was set to 21 mL/min. After confirming that the mixed solution was discharged from the nozzle, the nozzle was immersed in a coagulation liquid housed in the coagulation unit. As the coagulation liquid, an aqueous solution containing calcium chloride (manufactured by Canada Pharmaceutical Industries) as a coagulating agent and citric acid (manufactured by KENEI Pharmaceutical Co., Ltd.) as an acid compound was used. In the coagulation liquid, the content of calcium chloride was 1 wt %, and the content of citric acid was 2 wt %.

The discharge material (mixed solution) from the nozzle coagulated when coming into contact with the coagulation liquid. Accordingly, fibers were formed. These fibers were grasped by hand and set on a bobbin (made of silicon, diameter: 7.5 cm) of the winding unit. Next, the bobbin was driven to wind the fibers. At this time, the winding speed by the bobbin was set to 21 m/min. The stretching ratio of the fibers by the winding by the bobbin was 1.55.

When a sufficient amount of the fibers had been wound, the discharge of the mixed solution from the nozzle was stopped. Next, the fibers removed from the bobbin were cut with scissors. Water at 25 °C was poured on the obtained fibers and the fibers were washed for several minutes. An operation of wiping excess water from the fibers using KIMTOWELS was repeated three times.

Next, the produced fibers were cut to a length of 9.5 cm. The plurality of fibers were aligned in the direction in which the fibers extended, and were housed in a molding die made of silicone. The molding die had a housing portion having a rectangular parallelepiped shape with dimensions of 9.5 cm in length, 9.5 cm in width, and 3 cm in depth. Next, as a compound that promotes binding of the fibers, 8 g of a transglutaminase (Activa SuperCurd, manufactured by Ajinomoto Co., Inc.) was dispersed in 12 g of water to prepare a dispersion liquid. This dispersion liquid was added to the interior of the molding die. At this time, a 20-gauge plastic needle was stuck multiple times between the plurality of fibers to spread the dispersion liquid throughout the interior of the molding die.

Next, the upper part of the housing portion of the molding die was sealed with a wrap film, a presser (9.5 cm in length, 9.5 cm in width, and 3 cm in height) was placed thereon, and a 2-kg weight was placed on the presser. Accordingly, the interior of the molding die was pressurized from the atmospheric pressure of the ambient environment to 2.17 kPa. In this state, the molding die was set in a heating dryer (LC-114, manufactured by ESPEC CORP.) and heated at 50 °C for 45 minutes. Accordingly, a fiber aggregate of Example 1 in which the fibers were bound to each other was obtained. An image of this fiber aggregate is shown in FIG. 2.

### Example 2 and Comparative Example 1

A fiber aggregate of Example 2 and a fiber aggregate of Comparative Example 1 were obtained by the same method as in Example 1, except that the content of sodium alginate in the mixed solution used to produce fibers was changed as shown in Table 1.

### Comparative Examples 2 and 3

An attempt to produce fibers was made by the same method as in Example 1, except that the content of sodium alginate in the mixed solution used to produce fibers was changed as shown in Table 1. However, in Comparative Examples 2 and 3, the discharge material (mixed solution) from the nozzle did not coagulate even when coming into contact with the coagulation liquid, and no fibers were obtained.

### Comparative Example 4

A fiber aggregate of Comparative Example 4 was obtained by the same method as in Example 1, except that the sodium hydroxide aqueous solution was not added to the mixed solution used to produce fibers. In the mixed solution used in Comparative Example 4, the soybean protein was in a state of not being unfolded.

### [Compositions of Fiber Aggregates]

First, each of the fiber aggregates produced in Examples and Comparative Examples was cut into a 1 cm square and immersed in water at 25 °C for 3 minutes to prepare a fiber aggregate in a water-saturated state (test piece). Excess water adhering to the surface of the test piece was wiped off, the test piece was then set in a heating-type moisture meter (MX-50, manufactured by A&D Company, Limited), and heating treatment was performed at 105 °C. The heating treatment was performed until the rate of water loss in the test piece fell below less than 0.10 wt %/min. The water content R1 of the fiber aggregate in a water-saturated state was calculated using the above formula based on the weights of the test piece before and after the heating treatment.

Next, a weight ratio C1 of the solid component in the fiber aggregate in a water-saturated state was calculated as (100-R1) from the water content R1. The content R2 of the alginic acid compound in terms of sodium alginate in the fiber aggregate in a water-saturated state was calculated as the product of the weight ratio C1 and the weight ratio C3 of sodium alginate to the solid component in the mixed solution used to produce fibers. The results are shown in Table 1.

For the fiber aggregate of Example 1, the content R2 of the alginic acid compound was also determined by the colorimetric method described above. The colorimetric method was performed as follows.

### (Pre-Treatment)

First, 2 g of the fiber aggregate sample in a water-saturated state was accurately weighed into a 50-mL centrifuge tube, and 20 mL of a 1 wt % sodium bicarbonate solution (obtained by dissolving a guaranteed reagent manufactured by Sigma-Aldrich Co. LLC. in pure water) was added. Next, the mixture was heated in a water bath at 60 °C for 15 minutes and then stirred using a vortex mixer (VORTEX-Genie 2, manufactured by KENIS LIMITED). Next, centrifugation was performed using a centrifuge (bench-top multi-tube centrifuge LCX-100, manufactured by TOMY SEIKO CO., LTD.) at 3,500 rpm for 10 minutes, and the obtained supernatant was collected in a separate container. All subsequent centrifugations were performed under the conditions of 3,500 rpm and 10 minutes.

Next, 20 mL of a 1 wt % sodium bicarbonate solution was further added to the remaining precipitate, and the mixture was heated in a water bath at 60 °C for 15 minutes and then stirred using a vortex mixer. This was centrifuged, and the obtained supernatant was collected in a separate container. The supernatants collected from two batches were mixed, and 1 mol/L hydrochloric acid (manufactured by FUJIFILM Wako Pure Chemical Corporation) was added to the mixture to adjust the pH of the mixture to 2 to 3. Furthermore, 20 mL of pure water was added, and the mixture was allowed to stand for 60 minutes, and then centrifuged. The supernatant was removed, and the precipitate was collected.

40 mL of 1.1 mol/L sulfuric acid (10% sulfuric acid, manufactured by FUJIFILM Wako Pure Chemical Corporation) was added to the obtained precipitate, and the mixture was stirred for 3 minutes using a vortex mixer. This was centrifuged, the supernatant was removed, and the precipitate was collected. The same procedure was performed one more time on the remaining precipitate. A 3 mol/L sodium hydroxide aqueous solution (manufactured by FUJIFILM Wako Pure Chemical Corporation) was added to the precipitate to suspend the precipitate therein and adjust the pH to 9 to 10. Next, 1 mL of a mixed solution containing magnesium sulfate heptahydrate (manufactured by FUJIFILM Wako Pure Chemical Corporation) at a concentration of 1 mol/L and sodium sulfate (anhydrous) (manufactured by FUJIFILM Wako Pure Chemical Corporation, guaranteed reagent) at a concentration of 2.2 mol/L was added, and the mixture was heated in a water bath at 80 °C for 10 minutes.

Next, the mixture was cooled to room temperature and then centrifuged, and the obtained supernatant was collected in a separate container. At this time, if necessary, the supernatant was filtered through filter paper No. 5A. 2 mL of a 2.5 mol/L sodium sulfate aqueous solution (obtained by dissolving a guaranteed reagent manufactured by FUJIFILM Wako Pure Chemical Corporation in pure water) was added to the remaining precipitate, and the mixture was stirred using a vortex mixer. This was centrifuged, and the supernatant was collected and mixed with the previous supernatant.

1 mol/L hydrochloric acid was added to the supernatant mixture to adjust the pH to 3 to 4. 3 mL of a 10 wt % copper sulfate solution (manufactured by FUJIFILM Wako Pure Chemical Corporation) was added, and pure water was further added to adjust the volume to 20 mL using a volumetric flask. The mixture was allowed to stand for 60 minutes and then centrifuged, the supernatant was removed, and the precipitate was collected. 10 ml of water with a pH of 4 (obtained by adding 1 mol/L hydrochloric acid to pure water to adjust the pH) was added to the precipitate, and the mixture was stirred using a vortex mixer to disperse the precipitate in water. The mixture was centrifuged, the supernatant was removed, and 1 mL of 1 mol/L ammonia water was added to the precipitate to dissolve the precipitate. Using pure water and a volumetric flask, a constant volume of 50 mL was ensured to prepare a test solution.

### (Colorimetry)

Next, 100 mg of 1,3-naphthalenediol (manufactured by FUJIFILM Wako Pure Chemical Corporation, first grade reagent) was accurately weighed, 25 mL of pure water was added, and the mixture was stirred for dissolution to prepare a color solution. 2 mL of the above test solution was accurately weighed into a 50-mL centrifuge tube, and 4 mL of a copper-hydrochloric acid reagent (obtained by mixing 1 mL of a 2.5 wt % copper (II) sulfate solution and 9 mL of pure water into 40 mL of concentrated hydrochloric acid) was added. 2 mL of the color solution was added thereto, and the mixture was heated with boiling water for 65 minutes and then cooled in an ice bath.

Next, 8 mL of butyl acetate (manufactured by FUJIFILM Wako Pure Chemical Corporation, guaranteed reagent) was added, and the mixture was stirred using a vortex mixer. This was centrifuged, and the butyl acetate layer was then filtered through filter paper No. 5C to obtain a measurement solution. The measurement solution was put into a quartz cell (two-sided transparent) with a screw cap and a path length of 10 mm, and the absorbance (wavelength: 566 nm) was measured using a UV-visible-near-infrared spectrophotometer (V-750, manufactured by JASCO Corporation). The amount of sodium alginate (μg/mL) in the measurement solution was determined using a calibration curve described below, and the content of sodium alginate (g/kg) was calculated using the following formula.

Content of sodium alginate in fiber aggregate (g/kg)=(A×V)/(W×1000)
A: Concentration of sodium alginate in the measurement solution (μg/mL)
V: Volume of the measurement solution (mL)
W: Amount of the fiber aggregate collected (g)

### (Calibration Curve)

Sodium alginate powder was accurately weighed, and pure water was used to increase the volume to 100 mL. After confirming that the sodium alginate was completely dissolved, 5 g of the obtained sodium alginate solution was accurately weighed into a 100-mL volumetric flask. Pure water was added to adjust the volume to exactly 100 mL to prepare a standard solution. 0 g, 1 g, 2 g, 4 g, and 6 g of the standard solution were accurately weighed, and pure water was added to each to adjust each weight to exactly 10 g to prepare test solutions for a calibration curve. These test solutions were subjected to colorimetry to obtain a calibration curve for sodium alginate. To obtain accurate measurement values that take into account the effects of the above-described pre-treatment and the treatment before colorimetry, colorimetry was also performed on sodium alginate (KIMICA ALGIN I-1G, manufactured by KIMICA Corporation) that had undergone the pre-treatment and the treatment before colorimetry. Specifically, the apparent sodium alginate content obtained from the colorimetry of the sample obtained by performing the pre-treatment and the treatment before colorimetry on sodium alginate alone was 12.5% of the weighed value (actual weight of the sample subjected to the pre-treatment). In light of this result, a value obtained by multiplying the measurement value (g/kg) obtained from the colorimetry after pre-treatment by 100/12.5 was adopted as the accurate amount of sodium alginate included in the fiber aggregate.

For the fiber aggregate of Example 1, the content R2 of the alginic acid compound determined by the above colorimetric method was 3.44 wt %. This value was almost the same as the content R2 value (3.50 wt %) calculated as the product of the weight ratio C1 of the solid component in the fiber aggregate in a water-saturated state and the weight ratio C3 of sodium alginate to the solid component in the mixed solution used to produce fibers.

### [Texture Evaluation]

Four panelists skilled in texture evaluation actually tasted the fiber aggregates produced in Examples and Comparative Examples. Using chicken breast meat (thoroughly cooked on both sides to a state suitable for eating), which is an example of meat that could serve as a target for mimicry, as a comparison target, sensory evaluation was performed for the hardness, juiciness, and fiber texture of the fiber aggregates. Specifically, the panelists evaluated the samples based on the following criteria through consensus.

### <Evaluation Criteria>.

### Hardness

∘: Hardness is almost the same as chicken breast meat.
Δ: Hardness is acceptable as chicken breast meat.
x: Hardness is significantly different from chicken breast meat.

### Juiciness

∘: Juiciness is almost the same as chicken breast meat, with a moist impression.
Δ: Slightly drier than chicken breast meat, but acceptable.
x: Significantly different from chicken breast meat, with a dry texture.

### Fiber Texture

∘: Fiber texture is almost the same as chicken breast meat.
Δ: There is a fiber texture but it is either excessive or insufficient compared to chicken breast meat.
x: Significantly different from chicken breast meat, with little to no fiber texture.

Furthermore, the overall textures of the fiber aggregates were evaluated using a 9-point preference scale. Specifically, each panelist evaluated the samples based on the following criteria, and the average score was calculated.

### <Evaluation Criteria>

9 points: Texture is the same as chicken breast meat and indistinguishable from chicken breast meat.
5 points: Texture is acceptable as chicken breast meat.
1 point: Texture is significantly different from the texture of chicken breast meat and unacceptable as a food.

TABLE 1

| | | | | Example | | | |
|---|---|---|---|---|---|---|---|
| | | | | 1 | 2 | | |
| Mixed | FUJIPRO 748 | | [wt %] | 7.5 | 7.5 | | |
| solution | I-1G | | [wt %] | 1.1 | 1.25 | | |
| composition | NaOH | | [wt ppm] | 1500 | 1500 | | |
| Mixed solution pH | | | | 10.3 | 10.3 | | |
| Coagulation | Citric acid | | [wt %] | 2 | 2 | | |
| liquid | CaCl₂ | | [wt %] | 1 | 1 | | |
| composition | | | | | | | |
| Fiber | Composition | Water content R1 | [wt %] | 72.7 | 73.0 | | |
| aggregate | | Alginic acid | [wt %] | 3.50 | 3.85 | | |
| | | compound | | | | | |
| | | content R2 | | | | | |
| | Texture | Hardness | | ○ | ○ | | |
| | | Juiciness | | Δ | Δ | | |
| | | Fiber texture | | Δ | ○ | | |
| | | Overall evaluation | | 5.3 | 6.3 | | |
| | | | | Comparative Example | | | |
| | | | | 1 | 2 | 3 | 4 |
| Mixed | FUJIPRO 748 | | [wt %] | 7.5 | 7.5 | 7.5 | 7.5 |
| solution | I-1G | | [wt %] | 0.5 | 0.1 | 0 | 1.1 |
| composition | NaOH | | [wt ppm] | 1500 | 1500 | 1500 | 0 |
| Mixed solution pH | | | | 10.3 | 10.3 | 10.3 | 7.0 |
| Coagulation | Citric acid | | [wt %] | 2 | 2 | 2 | 2 |
| liquid | CaCl₂ | | [wt %] | 1 | 1 | 1 | 1 |
| composition | | | | | | | |
| Fiber | Composition | Water content R1 | [wt %] | 69.6 | — | — | 70.1 |
| aggregate | | Alginic acid | [wt %] | 1.90 | — | — | 3.83 |
| | | compound | | | | | |
| | | content R2 | | | | | |
| | Texture | Hardness | | Δ | — | — | x |
| | | Juiciness | | Δ | — | — | x |
| | | Fiber texture | | x | — | — | Δ |
| | | Overall evaluation | | 4.3 | — | — | 2.3 |

The abbreviations in Table 1 are as follows.
FUJIPRO 748: Soybean protein (FUJIPRO 748, manufactured by FUJI OIL CO., LTD.)
I-1G: Sodium alginate (KIMICA ALGIN I-1G, manufactured by KIMICA Corporation)

The fiber aggregate of Example 1 had a texture close to chicken breast meat, as a whole, but was slightly drier than chicken breast meat. The fiber aggregate of Example 2 had a moist texture and was close to chicken breast meat in texture. The fiber aggregate of Comparative Example 1 was brittle and lacked a fiber texture compared to chicken breast meat. The fiber aggregate of Comparative Example 4 was harder and drier than chicken breast meat.

As described above, the fiber aggregates of Examples in which the water content R1 in a water-saturated state was 71 wt % or more and the content R2 of the alginic acid compound in terms of sodium alginate was 2.0 wt % or more had improved textures compared to Comparative Examples.

### INDUSTRIAL APPLICABILITY

The fiber aggregate of the present embodiment is suitable for use as an alternative food.

1. A fiber aggregate comprising a plurality of fibers, wherein
the fiber aggregate has a non-animal protein and an alginic acid compound including a divalent metal salt of alginic acid, and
in the fiber aggregate in a water-saturated state,
a water content is 71 wt % or more, and
a content of the alginic acid compound is 2.0 wt % or more in terms of sodium alginate.

2. The fiber aggregate according to claim 1, wherein
the water content is 88 wt % or less, and
the content of the alginic acid compound is 10 wt % or less in terms of sodium alginate.

3. The fiber aggregate according to claim 1, wherein a content of the non-animal protein in the fiber aggregate in the saturated state is 10 wt % to 27 wt %.

4. The fiber aggregate according to claim 1, wherein the non-animal protein includes at least one selected from the group consisting of soybean protein, pea protein, lentil protein, potato protein, seitan protein, amaranth protein, and quinoa protein.

5. The fiber aggregate according to claim 1, wherein the alginic acid compound further includes alginic acid.

6. The fiber aggregate according to claim 1 being edible.

7. The fiber aggregate according to claim 1, wherein an average fiber diameter of the plurality of fibers is 1 cm or less.

8. The fiber aggregate according to claim 1, wherein at least two fibers of the plurality of fibers are bound to each other.

9. A manufacturing method for a fiber aggregate including a plurality of fibers, wherein
the fiber aggregate has an alginic acid compound including a divalent metal salt of alginic acid,
the manufacturing method comprises a spinning step of discharging a mixed solution containing a non-animal protein, a monovalent metal salt of alginic acid, and an alkaline compound, into a coagulation liquid to form the fibers,
the coagulation liquid has a metal salt including a divalent metal ion, and
a content of the monovalent metal salt of alginic acid in the mixed solution is greater than 0.5 wt %.

10. The manufacturing method according to claim 9, wherein the coagulation liquid further contains an acid compound.

11. The manufacturing method according to claim 9, further comprising a washing step of washing the fibers taken out from the coagulation liquid.

12. The manufacturing method according to claim 11, wherein an alkaline aqueous solution or water is used as a washing liquid in the washing step.

13. The manufacturing method according to claim 9, further comprising a binding step of binding at least two fibers of the plurality of fibers to each other.

14. The manufacturing method according to claim 13, wherein, in the binding step, the at least two fibers are bound to each other in a state where the plurality of fibers are housed in a molding die.
